(19) United States
(12) Patent Application Publication
(10) Pub. No.: US 2009/0222210 A1
(43) Pub. Date: Sep. 3, 2009

(54) Method for determining the earthquake protection of buildings

(75) Inventors: Konstantin Meskouris, Alsdorf (DE); Hamid Sadegh-Azar, Aldenhoven (DE); Michel Berezowsky, Koln (DE); Holger Dumling, Koln (DE); Rudiger Frenzel, Hennef (DE)

Correspondence Address: GRIFFIN & SZIPL, PC, SUITE PH-1, 2300 NINTH STREET, SOUTH, ARLINGTON, VA, 22204, US

(73) Assignee: MICHEL BEREZOWSKY, KOLN (DE)

(21) Appl. No.: 10/362,649

(22) PCT Filed: Aug. 16, 2001
(86) PCT No.: PCT/EP01/09430

§ 371 Date: Jul. 10, 2006

(30) Foreign Application Priority Data
Aug. 23, 2000 (EP) 00118055.3

(51) Int. Cl. G01M 7/00; G01V 1/28

(52) U.S. Cl. 702/14; 702/56

(57) ABSTRACT

According to the invention, in the method for determining the earthquake protection of buildings, the natural frequency of a building is determined. Moreover, the natural frequency of the ground surrounding the building is determined. Thereafter, a rating value for the building is calculated based on a comparison of the natural frequency of the building to the natural frequency of the ground. Based on this rated value, the earthquake protection of a building can be determined. Preferably, a failure probability for the building and an average damage to the building are calculated on the basis of the rating value, depending on the magnitude of the earthquake.

The present invention refers to a method for determining the earthquake protection of buildings.

In particular for buildings in earthquake-prone areas, it is crucial to observe construction regulations specifically issued for these areas, in order to avoid damage to the building upon the occurrence of an earthquake. However, such construction regulations are often not met with for economic reasons so that a high economic damage is incurred in case of an earthquake. Moreover, structural deficiencies cause the death of a great number of people.

Presently, the safety of buildings in case of an earthquake is evaluated merely by visual inspection. A multitude of deficiencies, such as the quality of the materials used and the like, cannot be assessed in this way. Such visual inspections are suitable only to find substantial deficiencies. The resulting economic damage to a building cannot be estimated in this manner.

Another problem of assessing the damages occurring in case of an earthquake is the existence of only large-area maps of earthquake zones. These maps are made up from experiences gathered from previous earthquakes and from geologic studies. Due to the large areas of the individual earthquake regions, the maps always only give average values for areas of several 1,000 km². However, the subsoil is not homogeneous in areas of such large sizes, but varies rather often. Even minor variations of the subsoil, such as a soft intermediate layer, for example, can alter the behavior of the subsoil fundamentally in case of an earthquake. This change in behavior of the subsoil with respect to the average value stated in the map can be so substantial as to make impossible an estimate of the degree of damage to a building in case of an earthquake of a given magnitude.

It is the object of the invention to provide a method for determining the earthquake protection of buildings with which to better determine the damage to a building to be expected in case of an earthquake.

The object is solved according to the invention with the features of claim 1.

In the method of the invention, the natural frequency of a building is determined. The natural frequency of a building is the smallest frequency at which the building moves when oscillating freely. The invention further provides for the determining of the natural frequency of the ground. Thereafter, a rating number for the building is calculated based on a comparison of the building's natural frequency to the natural frequency of the ground. The rating number is directly related to the damage to be expected in case of an earthquake of a given magnitude. Based on the rating number, the expected damage to a building can be predicted.

Determining the natural frequency of a building is advantageous in that, independent of construction regulations and the question to what degree they have been materialized, an actual building-specific measured value is calculated. This measured value serves as the basis of the present method.

The natural frequency of the ground is determined by reading it from a table. Such tables are tables corresponding to related maps and containing the natural frequencies of the ground with respect to large earthquake areas. Although this natural frequency represents an average value for a large area and is no characteristic value for the ground surrounding the building, comparing these two frequencies already yields a rating number allowing for a substantially more exact prediction on the expected damage to a building than would be possible by a mere visual inspection.

The natural frequency of the ground is preferably calculated using the Nakamura method allowing for a more exact location-specific natural frequency of the ground to be determined. In the Nakamura method, first, the spectrum of the horizontal component and of the vertical component of existing ground oscillations is determined. The maximum value of the division of the horizontal spectrum and the vertical spectrum yields the natural frequency of the ground.

The natural frequency of a building is preferably assessed by rotating an eccentrically supported mass of an exciting device with an increasing number of rotation. Thereby, the building is caused to oscillate. The oscillations of the building are picked up by an acceleration pick-up sensor or a geophone. Thereafter, the natural frequency of the building is determined from the oscillation spectrum picked up. Thus, by simply accelerating a mass, it is possible to cause a building to oscillate such that the natural frequency of the building can be calculated. For example, this method can be practiced while the building is still inhabited. Therefore, the effort for determining the natural frequency is extremely low.

Preferably, the natural frequency of the building is determined by a Fourier transformation of the time response of the building during the acceleration of the mass. Particularly good results can be achieved if the exciting device is fastened to the building above 9/10 of the total height thereof. Preferably, the exciting device is arranged on the roof of the building,

Preferably, the rating number for a building is calculated on the basis of a building-specific basic rating. To this purpose, a computer stores a table with building-specific basic ratings in the form of a data base. For a determination of the rating number, the suer simply has to select the type of building. Then, the computer which is connected to the acceleration pick-up sensor automatically records the oscillations of the building. From these, the computer calculates the natural frequency of the building, preferably using a Fourier transformation, as described above. In a further step, the computer uses an acceleration pick-up sensor to record the ground acceleration and transform it into the ground frequency. Instead of recording the natural frequency of the ground, the computer may also take the average natural frequency of the ground for a large area from a stored file. Then, the computer finds the building-specific basic rating from the stored building table. By comparing both natural frequencies and with corresponding consideration to the basic rating, the rating number is determined. Taking the basic rating into consideration, which is based on a statistic evaluation of experiences and studies, has the advantage of taking the building type into account.

When calculating the rating number, particular consideration is given to the difference between the natural frequencies of the building and the ground. Most preferably, the building-specific rating is reduced by a frequency risk number also specific to the building, if the difference between the two frequencies is below a fixed threshold. This is done with the following equation:

$$\frac{ \begin{matrix}Natural frequency of building - natural \\ frequency of ground\end{matrix} }{Natural frequency of building} \qquad ( Eq . 1 )$$

If this quotient is smaller than a building-specific threshold number, the building-specific basic rating is reduced by the frequency risk value. Thus, a reduced rating is obtained for a small difference between the two natural frequencies. As a consequence, the building will be damaged already in case of a minor earthquake, and this can be determined correspondingly using the present method.

According to the invention, the building-specific basic rating is reduced by a ground risk value depending on the nature of the ground. These are values, for example, obtained from a statistic evaluation of scientific experiences and studies and accounting for offsets in the ground, intermediate layers and the like, for example.

A further change in the basic rating is effected by the computer if, depending on one or a plurality of building examination calculations, weakenings or reinforcements are to be expected. Effected building examination calculations performed by the computer will be detailed below in connection with the drawings. Preferably, the building examination calculation is taken into account by the computer evaluating each building examination calculation as positive or negative with respect to a threshold value. The basic number will be increased if all building examination calculations have been evaluated as positive. Simply speaking, this means that a building fulfills important criteria of earthquake standards. Preferably, the basic rating is increased only if additional, predefined building criteria are met.

The rating obtained is preferably used to calculate a mean damage probability as a function of the earthquake magnitude. Thus, the calculation yields the extent of the damage as a function of the earthquake magnitude. Knowing this extent, it is possible to make a simple estimate what degree of damage to a building is to be expected during an earthquake of a given magnitude. In addition to the mean damage rate (MDR), a failure probability, i.e. the probability of a complete destruction of the building, is calculated on the basis of the rating. Thus, it is possible, for example, to determine the degree of probability at which a collapse or a complete economic destruction of the building has to be expected for a certain magnitude of an earthquake.

The above method for determining the earthquake protection of buildings is particularly suited for insurance companies. Using this method, insurance companies have a tool for appraising the risk of damage and to calculate the insurance fees and the like from this appraisal.

The following is a detailed description of a preferred embodiment of the invention with reference to the accompanying drawings.

In the Figures:

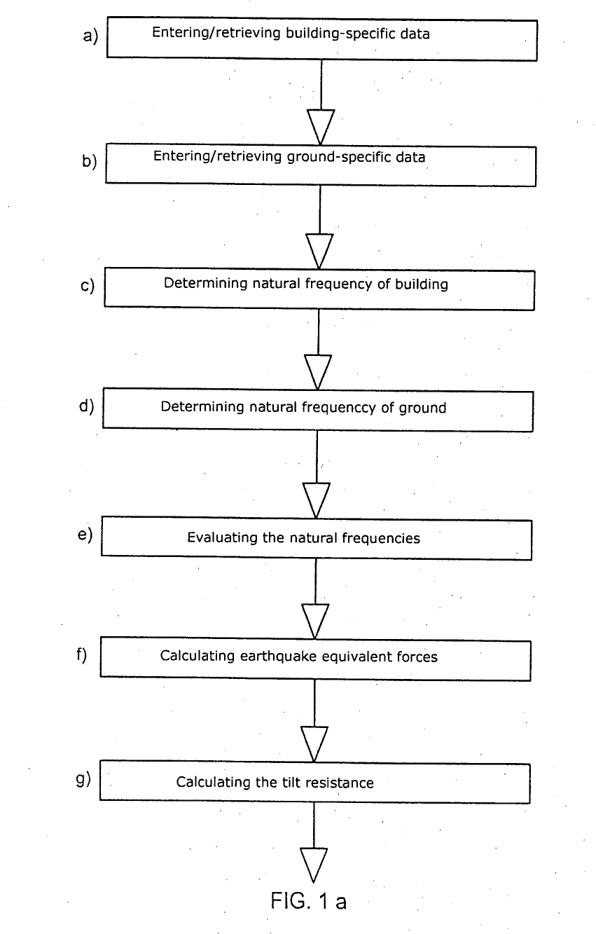

FIGS. 1a and 1b show a flow chart of a preferred embodiment of the method according to the present invention,

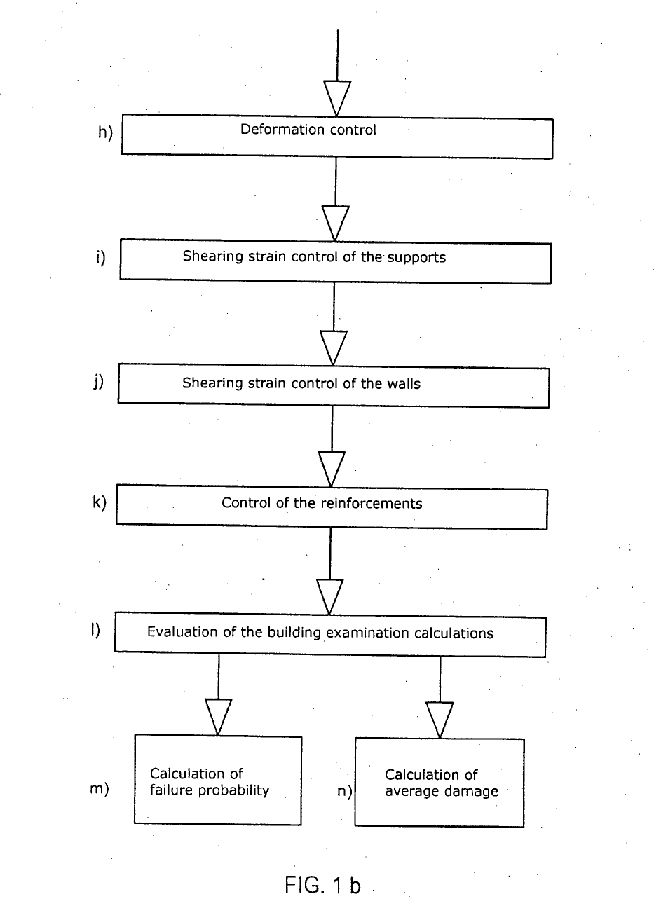

FIG. 2 illustrates an example of a diagram of the acceleration vs. time and of the amplitude vs. frequency derived therefrom for a building made to oscillate by the exciting devices,

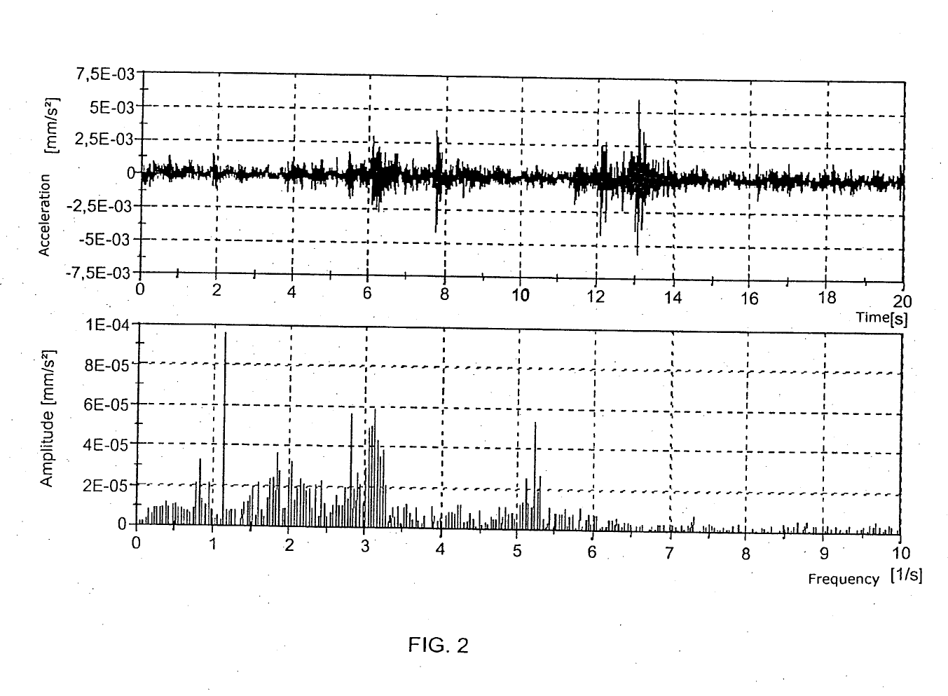

FIG. 3 a schematic representation for calculating the earthquake-equivalent forces, and

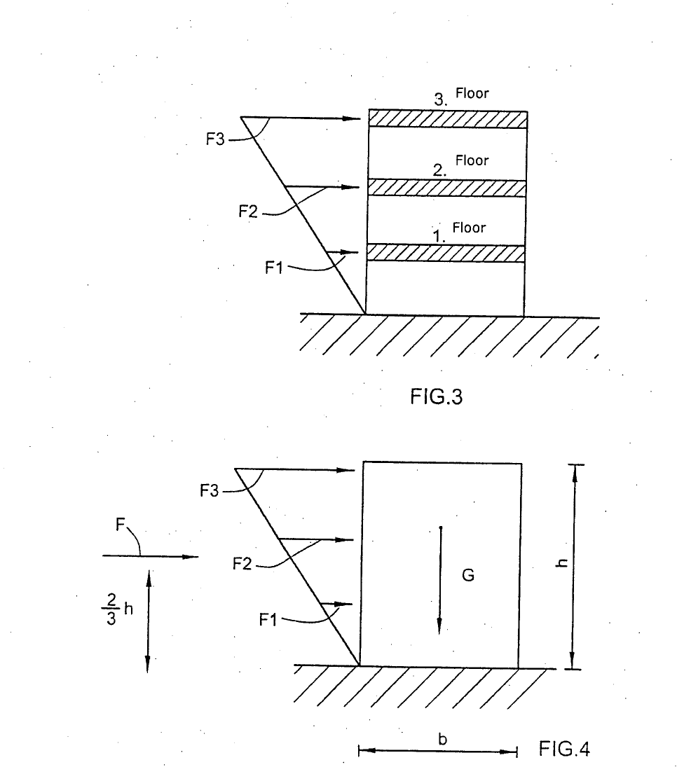

FIG. 4 a schematic representation for calculating the overturning moment of the building about the founding.

First, in step a), building-specific data are inputted, such as the address of the building, the exact position of the building, possibly with GPS data, etc. Next, the building type is entered. In total, a file in the computer, into which the data are entered, stores 15 different building types in a table. For example, these are wooden, steel or steel concrete buildings of different types. Each building type is associated to a basic rating specific to the building. The basic rating results from empiric values of geologists, seismologists, engineers engaged in statical calculations, and the like. It represents a kind of basic stability of the building. Based on this basic rating, a computer performs the calculation of the earthquake protection of buildings as described below. To enter the basic rating, it is merely necessary to select the building type and the location-specific data since the basic rating required therefor is stored in a file in the computer.

In step b), ground-specific data in the form of ground classifications are entered or retrieved. These are assessments of the structure of the ground layer the building is located on. Specifically, consideration is given to the strength and the thickness of ground layers and the like. Such data are known, for example, from geologic maps and earlier studies in the relevant area. Depending on the nature of the ground, a ground-specific rating is determined. Preferably, the computer again contains a file listing individual types of ground so that one merely has to select the type of ground, while the computer automatically assigns a numerical value to the respective type of ground. Then, in the preferred embodiment of the method, this numerical value is subtracted from the basic rating. For a ground advantageous for the earthquake protection of a building, the basic rating is not altered. Possibly, the basic rating may also be increased if the ground strongly attenuates the oscillations occurring during an earthquake, for example.

In step c), the natural frequency of the building is determined. This is done, as described before, by mounting an exciting device on the roof or in a higher floor of the building. The exciting device comprises an eccentrically supported mass that is rotated with the rotational speed increasing. Thereby, the building is caused to oscillate. These oscillations are measured by an oscillation pick-up sensor or a geophone. The measured results are automatically transmitted to the computer. The measured result is the acceleration versus time. The top diagram in FIG. 2 illustrates an example of such an oscillation curve. Using the computer, the acceleration diagram is transformed into an amplitude diagram. The bottom diagram in FIG. 2 illustrates a corresponding amplitude diagram. The conversion of the acceleration values into amplitude values is performed using a Fourier transformation. This is effected by the following equation:

$$G ( ω ) = {\int }_{- ∞}^{+ ∞} g ( t ) \cdot {e}^{- i ω t} d t \qquad ( Eq . 2 )$$

Here, G(ω) represents the frequency range and g(t) represents the function of the acceleration depending on time. With the help of this transformation, the diagram of the amplitude vs. the frequency is determined according to the bottom diagram of FIG. 2. This diagram gives the natural frequency of the building. The natural frequency of a building is the frequency with the highest amplitude. In the example illustrated, this is true for the frequency f=1,133 Hz. The natural frequency is thus determined automatically using an exciting device, an acceleration pick-up sensor and a computer.

The natural frequency of the ground is determined in step d). As described above, the same may be stored as a table in the computer, the table listing area-dependent natural frequencies of the ground. Since the position of the building to be examined had been entered in step a), in step d), the computer can automatically read the corresponding value of the natural frequency of the ground from the corresponding table. A better result can be achieved by obtaining the natural frequency of the ground, since the exact natural frequency of the ground at the location of the building is then taken into consideration. This is not true for known natural frequencies of the ground, since these are available only for large areas, i.e. in the form of an average value.

The natural frequency of the ground may be obtained by means of an acceleration pick-up sensor or, preferably, a geophone, since the ground is constantly caused to oscillate by micro-seismic movements. The natural frequency of the ground is obtained using the Nakamura method.

In the subsequent step e), the natural frequency is evaluated by comparing the natural frequency of the building to the natural frequency of the ground. To this end, the following calculation is performed:

$$\frac{ \begin{matrix}Natural frequency of building - natural \\ frequency of ground\end{matrix} }{Natural frequency of building} \qquad ( Eq . 3 )$$

This ratio is compared to a threshold value specific to the building. This threshold value may be stored in a table as a numerical value for each type of building. Since this counter value differs only slightly for the various building types, it is possible to store a common, empirically obtained threshold value for all buildings or groups of buildings. If the value obtained from equation 3 is smaller than the threshold value, the basic value specific to the building and to the location is automatically decreased by a predetermined value. The result obtained is a preliminary rating value for the earthquake protection of the building. A definitely more exact estimate of the earthquake protection of the building could already be calculated from this rating value than would be possible with the known methods, such as a visual inspection.

In step f) of the present method, earthquake equivalent forces are calculated. The calculation of earthquake equivalent forces is necessary for the subsequent steps. The earthquake equivalent forces are calculated according to the calculation methods formulated in Eurocode 8 (Design of structures for earthquake resistance DIN ENV, 1998; part 1, 2 § 3.3.2.2.) or on the basis of the calculation method in NEHRP (National Earthquake Hazard Reduction Program; 1988). According to Eurocode 8, an overall earthquake force F_{b} is calculated first as follows:

F_{b}=S_{d}(T₁)·W (Eq. 4)

Here, S_{d}(T₁) represents the ordinate of the design spectrum (Eurocode 8; part 1.1; § 4.2.4.) for a basic oscillation time (T₁), (T₁) is the basic oscillation time of the building for the translation movement in the direction viewed, and W is the total weight of the building.

Then, the earthquake equivalent forces F₁ are calculated. For example, these are the earthquake equivalent forces F₁, F₂ and F₃ (FIG. 3) acting as horizontal forces on the individual floors. The individual earthquake equivalent forces are calculated by:

$${F}_{i} = {F}_{b} \cdot \frac{{Z}_{i} \cdot {W}_{i}}{\sum {Z}_{j} \cdot {W}_{j}} \qquad ( Eq . 5 )$$

Here, Zᵢ, Zⱼ are the heights of the masses mᵢ, mⱼ above the plane on which the earthquake effect (founding) acts, and Wᵢ, Wⱼ are the weight of the respective masses mᵢ, mⱼ.

The masses mᵢ, mⱼ are calculated according to Eurocode; part 1, 2; § 3.1. Using this calculation, the individual earthquake equivalent forces F₁, F₂, F₃ acting on the floors are determined (FIG. 3).

In step g), the tilt resistance of the building is calculated based on the earthquake equivalent forces (FIG. 4). To this end, an equivalent force F of the forces F₁, F₂, F₃ is set at ⅔ of the total height of the building. The tilt moment Mₖᵢₚₚ is calculated from:

$${M}_{kipp} = Fx \frac{2}{3} h \qquad ( Eq . 6 )$$

Further, a resistance moment M_{w} of the building is calculated to determine the tilt resistance:

$${M}_{w} = G \cdot \frac{b}{2} \qquad ( Eq . 7 )$$

Here, G is the total weight of the building, b is the width of the building, and h is the height of the building.

When determining the loads, consideration is given to the fact that the building not only has its actual own weight, but also an operation weight, i.e. inventory and people. The tilt moment Mₖᵢₚₚ is compared to the resistance moment M_{w}. Based on this comparison, the calculation of the tilt resistance made in step g) is rated “positive” or “negative”. For example, a ratio of both moments could be compared to a threshold value specific to a building.

The result of the calculation in step g), i.e. the rating “positive” or “negative” is stored temporarily.

In step h), a deformation control is performed. Here, the transverse forces occurring in each support of a building are calculated, the transverse force in each support corresponds to the total transverse force of the floors divided by the number of supports in a simplified approximation. From this, a relative floor displacement is calculated for each floor by:

$${v}_{c} \cdot {q}_{d} \cdot ( \frac{h}{12 E} ) \cdot ( \frac{{K}_{b} + {K}_{c}}{{K}_{b} \cdot {K}_{c}} ) \qquad ( Eq . 8 )$$

Here, V_{c} is the shear force in a support, q_{d} is the behavior coefficient of the displacement, h is the height of the floor, E is the module of elasticity

$${K}_{b} = \frac{I}{L}$$

$$and$$

$${K}_{c} = \frac{I}{h} ,$$

where I is the moment of inertia and L is the length of the bar.

The result is compared to an allowable deformation. Depending on a predetermined threshold specific to the building that is stored in a corresponding table in the computer, the comparison leads to the rating “positive” or “negative”. Again, this rating is stored temporarily.

In step i), a shearing strain control is performed for the supports. From the transverse force in each support, the shearing strain in the respective support is calculated depending on the geometric conditions. These values are compared to the average common allowable shearing strain. The allowable strains are also stored in a table in the computer, depending on the material used. For the allowable strains, one preferably calculates with a high security factor since the quality of the material used, i.e., for example, the quality of the steel or the steel concrete, is not known exactly. The comparison again leads to a rating “positive” or “negative”. Again, this rating is stored temporarily.

In the next step j), a shearing strain control of the walls is performed. To this ed, the shearing strain in the walls is calculated from the respective transverse force on a floor:

$$Shearing strain = \frac{Transverse force on floor}{\begin{matrix}Sum of all cross \text{-} sectional areas \\ of the laterally reinforcing walls\end{matrix}} \qquad ( Eq . 9 )$$

This value is compared to an allowable shearing strain. The same is stored in a corresponding table according to the allowable strain when making the calculation of step i), again calculating with a high security factor since the exact quality of the material is not known. The rating result is latched.

In step k), the last building examination calculation is the control of the diagonal reinforcements. The tensile stress and compressive strain in the reinforcements are calculated and subsequently compared to the allowable values:

$$\begin{matrix}Tensile \text{/} compr . \\ stress\end{matrix} = \frac{ \begin{matrix}Transverse force \\ on floor\end{matrix} }{\begin{matrix}Total cross \text{-} sectional \\ area of reinforcements\end{matrix}} \cdot \frac{\begin{matrix}Mean length of \\ reinforcements\end{matrix}}{\begin{matrix}Mean distance \\ Between supports\end{matrix}} \qquad ( Eq . 10 )$$

The reinforcements are beams generally extending obliquely between building supports.

Again, the results of this calculation are compared to allowable values stored in a table. The comparison yields the ratings “positive” or negative”. Once more, this rating is latched.

From the building examination calculations in steps g) to k), a respective result “positive” or “negative” is known and stored in the computer.

In the next step l), the building examination calculations of steps g) to k) are evaluated. The evaluation leads to a building structure value being subtracted from or added to the basic rating. Preferably, a value is added if all building examination calculations were “positive”. As soon as one of the building examination calculations is “negative”, the basic rating that possibly has been changed in step e) because of the natural frequencies occurring, remains unchanged in step l). It is also possible to change the basic rating after each of steps g) to k). Instead of subtracting or adding fixed values, factors may be introduced by which the basic rating is multiplied.

Based on the calculation results, a rating value is obtained. This is comprised of the basic rating and the corresponding subtracted or added values from the calculations in steps e) and l).

In step m, the failure probability is calculated. This is the probability of the building being destroyed completely by an earthquake depending on the magnitude thereof, a complete destruction meaning at least an economically complete destruction such that rebuilding the edifice is not lucrative. The failure probability is calculated by:

Rating value of building=−log(failure probability) (Eq. 11)

In parallel to step m), the average damage is calculated in step n) as a function of the earthquake intensity. This is a percentage of the damage in case of a weak, medium or strong earthquake, for example. The individual numerical values allow for an estimate of the degree of damage to a building in case of a corresponding earthquake. The damage is calculated by a mathematic approximation of the logarithmic normal distribution. The region below the damage distribution of the average damage probability of 60% to 100% corresponds to a probability of damage of more than 60%. The average damage probability q is calculated from:

$$Rating value of the building = - \frac{ln ( q )}{ln ( 10 )} \\ where \\ q = ( {b}_{1} \cdot t + {b}_{2} \cdot {t}^{2} + {b}_{3} \cdot {t}^{3} + {b}_{4} \cdot {t}^{4} + {b}_{5} \cdot {t}^{5} ) \cdot Zx ; \\ Zx = {0.39894228}^{( - {x}^{2} \cdot 1 / 2 )} ; \\ t = \frac{1}{( 1 + p \cdot X )} \\ and \\ X = \frac{( ln ( 60 ) - ln ( {x}_{m} ) )}{S} \qquad ( Eq . 12 )$$

Here,

xₘ is the average value of the logarithmic-normal damage distribution,
s is the standard deviation of the logarithmic-normal damage distribution,
b₁=0.31938153
b₂−0.356563782
b₃=1.781477937
b₄=−1.821255978
b₅=1.330274429
p=0.2316419

According to the invention, it is not necessary to perform all steps a) to m) or n), respectively. The essential steps are steps c), d) and e), from which a result regarding the earthquake protection of a building may already be derived. Thus, it is possible, for example, to perform step m) or n) immediately after step e). Likewise, individual steps in which a building examination calculation is performed, i.e. one or more of the steps g) to k), could be omitted. Further, a combination or a weighting of these individual steps is possible. Since the basic rating is preferably altered by addition or subtraction, the sequence of the individual steps is interchangeable.

For example, a simple calculation for a steel frame building is performed as follows:

A steel frame building has a location with a high earthquake intensity, thus giving a basic rating of 4.5. For soft ground with soft to hard intercalations of clay in a depth of about 10 m, a ground risk value of 0.6 is subtracted so that the basic rating has decreased to 3.9 even after step b). After determination of the natural frequency of the ground and of the building, the natural frequencies are evaluated in step e). Is this evaluation greater than 15%, a value of 0.8 will be subtracted from the basic rating already reduced. If this value is not greater than 15% after comparison of the natural frequencies, the rating value, i.e. the already reduced basic rating, will remain unchanged. Subsequently, the building examination calculations are performed in steps g) to k). If all building examination calculations are “positive”, the value is increased by 2. As soon as a calculation is “negative”, the value remains unchanged. If the compared value of the natural frequencies is greater than 15% and at least one building examination calculation is “negative”, a value of 3.7 is obtained. From this, a failure probability of 10^{-3.7} is calculated. Thus, the failure probability is 0.02%. For a rating value of 3.7, an average damage of 15% is obtained from equation 12.

1. A method for determining the earthquake protection of buildings, the method comprising the following steps:
determining the natural frequency of a building;
determining the natural frequency of the ground,
calculating a rating value for the building on the basis of a comparison of the natural frequency of the building to the natural frequency of the ground, and
calculating an average degree of damage on the basis of the rating value depending on the magnitude of the earthquake.

2. The method of claim 1, wherein the natural frequency of the building is determined
by rotating an eccentrically supported mass of an exciting device with an increasing number of rotations, whereby the building is caused to oscillate,
by picking up the oscillations of the building by means of an acceleration pick-up sensor, and
by determining the natural frequency of the building by the spectrum of the oscillations picked up.

3. The method of claim 2, wherein the exciting device is mounted to the building above 9/10 of the total height thereof.

4. The method of one of claims 1-3, wherein a basic rating specific to the building is taken from a stored building table for calculating the rating value.

5. The method of one of claims 1-3, wherein the rating value is calculated as a function of the frequency difference between the natural frequency of the building and the natural frequency of the ground.

6. The method of claim 4 or 5, wherein the basic rating is reduced by a frequency risk value specific to the building, if
$$\frac{ \begin{matrix}Natural frequency of building - natural \\ frequency of ground\end{matrix} }{Natural frequency of building}$$
is greater than a threshold value specific to the building.

7. The method of one of claims 4-6, wherein the basic rating is reduced by a ground risk value depending on the nature of the ground.

8. The method of one of claims 4-7, wherein, in addition, one or more building examination calculations are performed and the basic rating is changed by a structure value of the building, depending on the calculation result.

9. The method of claim 8, wherein each building examination calculation is rated positive or negative, depending on a threshold value, and wherein the basic rating is increased, if all building examination calculations have been rated positive.

10. The method of claim 9, wherein building criteria are defined and the basic rating is increased only if all building criteria are positive.

11. The method of one of claims 1-10, wherein a failure probability is calculated on the basis of the rating value.

12. (canceled)
